(19) United States
(12) Patent Application Publication
(10) Pub. No.: US 2017/0123439 A1
(43) Pub. Date: May 4, 2017

(54) Regulators and Portable Power Systems

(71) Applicant: MEKONG INVESTMENTS LIMITED, Tortola (VG)

(72) Inventors: Robin Koenig, Middleburg, VA (US); Michael Wittman, Rodgau (DE)

(21) Appl. No.: 15/339,289

(22) Filed: Oct. 31, 2016

Related U.S. Application Data
(60) Provisional application No. 62/249,034, filed on Oct. 30, 2015.

(51) Int. Cl. G05D 16/16; G05D 16/10

(52) U.S. Cl. CPC G05D 16/166; G05D 16/106

(57) ABSTRACT

Regulators and/or parts or components thereof useful, for example, in systems for powering pneumatic tools. In certain embodiments, dual-stage regulators wherein each stage of the regulators is adjustable and/or tunable. In certain preferred embodiments, tunable and/or adjustable dual-stage regulators which are capable of being used, selectively as desired, in low and/or high pressure applications, shot-type and/or continuous flow delivery applications, and/or low and/or high volume applications (or any combination thereof). In certain additional embodiments, in combination with or separate from the features of other embodiments described herein, regulators which exhibit stable performance regardless of, for example, cylinder supply pressure.

### RELATED APPLICATION DATA

This application claims priority to U.S. Provisional Patent Application No. 62/249,034, filed Oct. 30, 2015, entitled REGULATORS, AND PORTABLE POWER SUPPLY SYSTEMS AND METHODS FOR USING THE SAME. This application incorporates the following applications or patents by reference, in their entirety: U.S. Patent Application No. 60/977,374, filed Oct. 3, 2007, entitled PNEUMATIC REGULATOR ASSEMBLIES, POWER SUPPLY SYSTEMS AND METHODS FOR USING THE SAME; International Application No. PCT/US2007/88865, filed Dec. 26, 2008, entitled PNEUMATIC REGULATOR ASSEMBLIES, POWER SUPPLY SYSTEMS, AND METHODS FOR USING THE SAME; U.S. Pat. No. 6,932,128, entitled APPARATUS AND METHOD FOR USING A LIGHTWEIGHT PORTABLE AIR/GAS POWER SUPPLY; and International Application No. PCT/US08/78868, filed Oct. 3, 2008.

### FIELD OF THE INVENTION

The present invention relates to regulators (and/or parts or components thereof), portable pneumatic power supply systems using such regulators, and methods of using the same.

### BACKGROUND OF THE INVENTION

A tremendous variety of tool types and the like have been developed over the centuries to address the many numbers of construction and manufacturing arts which have evolved during civilization's technological progress through modern times. For example, in a single industry such as the construction industry, dozens of different tool types may be used on a single construction site. In particular, the number of such tool types which are used has increased due to the various specialties and subspecialties of carpentry and other construction techniques which continue to develop as modern buildings become more complex.

Throughout this evolution, substantial efforts have been made to automate tool operation, principally, to improve job efficiencies by improving tool operation speeds and by reducing fatigue of tool operators. In recent decades, such automation efforts have typically involved the development or innovation of compressor powered pneumatic tools or tools powered by electricity. In this regard, due to their improved efficiencies, the use of automated tools has become so commonplace that one would be hardpressed to not find a pneumatic nail gun or an electrically powered drill at a typical construction job site. Nevertheless, conventional pneumatic or electrically operable tools suffer various disadvantages or drawbacks.

For example, pneumatic or electrically powered tools which are directly connected to a compressor via a hose or to an electrical outlet via a power cord are limited in their portability or mobility due to their attachment to their respective power sources (e.g., their portability is limited to the length of the hose or cord and/or they may be difficult or unsafe to carry up a ladder for example). Moreover, the longer the cord or hose, the greater the overall weight as well as the chance that such hose or cord will become entangled or otherwise act as a safety hazard (e.g., as a tripping hazard). Although battery operated tools address some of these disadvantages, such tools are burdened by their own drawbacks such as their increased weight and reliance on the finite charge of a battery (and, after battery depletion, one must wait for the battery to be recharged or have additional batteries available, for example).

Although U.S. Pat. No. 6,932,128, entitled APPARATUS AND METHOD FOR USING A LIGHTWEIGHT PORTABLE AIR/GAS POWER SUPPLY has addressed or mitigated some of the above described drawbacks, the present invention is intended to, at least in part, further improve on the apparatus and methods disclosed therein as well as provide other improvements not necessarily addressed towards technologies specifically disclosed in the '128 patent. In particular, the present invention is intended to provide substantial improvements in regulator design for use, for example, with systems such as described in the '128 patent. For example, certain types of pneumatic tools, such as nail guns, require short bursts of pressurized air (“air” being used generically throughout this application, interchangeably with “gas” or “air/gas”, to include all other suitable gases such as nitrogen or helium), while others, such as pneumatic powered screw drivers, require a continuous flow of air, often at high pressures, over the duration of tool operation. Similarly, certain types of pneumatic “jobs” or projects are best addressed with low pressure, continuous flow air delivery such as the filling of a bicycle tire or a basketball or soccer ball (i.e., employing high pressure bursts or high pressure continuous flow in such applications may damage or burst the tire or ball). Still furthermore, certain more demanding applications, such as the operation of the certain cutting devices such as the “jaws of life” or a lift bag (e.g., each employed by fire departments in emergency operations) or certain impact wrenches, require high volume air delivery in addition to high pressure and continuous flow. In light of the existence of these numerous applications and job types, each with their own air delivery requirements, it would be desirable to have a single regulator which is capable, because of its configuration or design, of being used in such (or other) alternative application or job types (e.g., with a system such as disclosed in the '128 patent) with or without regulator adjustment or part swapping being required when switching between such applications or job types. In certain optimum designs, it would be desirable, of course, to have a single regulator which is capable of delivering air, alternatively (e.g., selectively, as desired), at both low and high pressures, in bursts (shots) or as continuous flow, and/or in low or high volume (or in any combination of the herein listed delivery types) without requiring part swapping and/or significant regulator adjustment (or no regulator adjustment, other than of the output pressure adjustment mechanism, after an initial adjustment generally temporally proximal the installation of the regulator on the high pressure cylinder or bottle).

Additionally, employing known regulator designs, it is common to experience unwanted pressure variations during regulator operation. As one example of such a deficiency in prior known regulator designs, as the high pressure air source (for example, a steel, aluminum, or carbon fiber cylinder or “bottle”) is depleted or the air or gas pressure supplied by the source is reduced, the output pressure delivered by the regulator typically increases (i.e., it is believed that this is because less pressure is initially available in the low pressure chamber to deflect the low pressure piston, and therefore allow regulator seat closure by the regulator pin, to allow air flow delivery to the low pressure chamber to be timely stopped). This unexpected result causes problems in certain types of regulator operation, such as when used with portable air power systems, because, for example, certain tool types will be damaged or will not operate properly (e.g., they may drive a nail too deeply) if subjected to air pressures above threshold limits. In view of the above enumerated drawbacks and/or desires for improvements in the art, it is a purpose of the herein described invention to address one or more of such drawbacks and/or desires as well as, or in the alternative, other needs which will become more apparent to the skilled artisan once given the present disclosure.

### SUMMARY OF CERTAIN EMBODIMENTS OF THE INVENTION

Generally speaking, the present invention is directed, in certain example embodiments, to regulators (or parts or components thereof) which have configurations which exhibit improved performance (e.g., such as improved gas pressure delivery stability). In such or other example embodiments, regulators are provided which have configurations which exhibit improved operational capabilities (e.g., such as with respect to range of gas pressure delivery, type of gas delivery, and/or volume of delivery). In at least one preferred example embodiment, a regulator is provided which includes two stages with each stage being user adjustable to tune operational performance. In certain example embodiments, the present invention provides: a regulator comprising: a regulator body including an inlet port for connecting to a high pressure gas supply, and the regulator housing a first stage and a second stage; the first stage including a first regulator piston and a first regulator seat for regulating air delivery between a high pressure chamber and a low pressure chamber of the regulator; the second stage including a second regulator piston and a second regulator seat for regulating air delivery between the low pressure chamber and an output pressure chamber; an output port in selective gas flow communication with the output chamber for delivering gas pressure at a desirable output pressure; a first adjuster mechanism in communication with the first stage for adjusting at least one operational parameter of the first stage; a second adjuster mechanism in communication with second stage for adjusting at least one operational parameter of the second stage; and wherein the first adjuster mechanism and the second adjuster mechanism are each adjustable, alone or in combination, to tune performance of the regulator to have desirable operational characteristics. In this or other example embodiments, the second adjuster mechanism is adjustable to select a desired operational output pressure for delivery by said output port (e.g., for use by pneumatically powered tools and the like). In such or other example embodiments, the first and second adjuster mechanisms are adjustable to selectively tune said regulator to be capable of delivering gas, via said outlet, in the alternative or in combination, at low pressures, at high pressures, at low volume, at high volume, in shots, and as continuous flow.

In yet a further example embodiment, the first and second stages are housed in a single regulator body (i.e., the regulator is a substantially unibody design). If desired, in any one or combination of the preceding embodiments, the regulator is so designed such that the regulator cap can be removed while the regulator is attached to a pressurized high pressure cylinder without the high pressure cylinder substantially depressurizing. In certain other contemplated examples, in any one or combination of the preceding embodiments, the regulator is so designed such that the Belleville-type springs (other spring types may of course be employed) may be selectively removed and replaced with springs of another type or of another “spring bias or strength rating” to thereby change the psi output of the regulator according to a desired selected end use. In certain preferred example embodiments (either as described specifically above or in any combination or subcombination thereof), the psi output which can be changed is selected from the group comprising: maximum psi output, psi range output, minimum psi output, or some combination of the herein listed output variables.

In certain exemplar embodiments, a unique configuration of a cartridge assembly, comprised of a combination of a cartridge body (an example configuration of which is illustrated herein), a regulator pin, a regulator seat, and a biasing mechanism (e.g., spring), is achieved as a self-contained, removable module. The use of such module, in such example regulator configurations, lends to ease of maintenance and/or repair of the regulator as well as, or in the alternative, ease of manufacture and/or increased reliability. In some preferred example embodiments, the psi range output can be quickly changed simply by switching out the Belleville (or other type) spring pack. For example, such a regulator may be converted to be capable of switching between 0-150 psi output and 0-300 psi output (in practice, conventionally to 150-300 psi output) by a simple spring pack (or biasing mechanism pack) switch-out. This is important, in at least one respect, where it is desired to use such regulator (e.g., as part of a portable power supply system) for a variety of end use types ranging from inflating sports balls such as basketballs or soccerballs to more high pressure applications such as for powering impact wrenches or operating emergency lift bags and the like.

In various exemplary embodiments the regulator is designed to connect to a source of pressurized air, such as a portable canister. In such embodiments the canister is preferably small enough to be carried by a user and connects through the regulator to a hose to be operatively coupled to any number of pneumatic tools.

In various exemplary embodiments, the flow of the gas from the high pressure chamber to the low pressure chamber may be regulated by a tunable or adjustable high pressure piston assembly and a high pressure pin assembly. Further, in such example or other embodiments, the flow of gas from the low pressure chamber to the output chamber may be regulated by a tunable or adjustable low pressure piston assembly and a low pressure pin assembly. In still other embodiments, one or both of the high and low pressure piston assemblies are adjustable and/or tunable to ensure predictable, unchanging output pressure regardless of decreases in source pressure (e.g., provided by a high pressure cylinder connected to the regulator).

In some of the herein described embodiments, the longitudinal position of the inner piston within the outer piston is user adjustable (e.g., for regulator tunability), and the regulator may further include a knob for user adjustment of the low pressure piston. Further, in some embodiments, the regulator may be capable of receiving air/gas at the air inlet port at a pressure of between at least 0-6000 PSI and stepping down such air/gas pressure, to deliver such air/gas from the air/gas outlet port, in certain preferred example embodiments, at pressures selected between 150-300 PSI, and in more preferred example embodiments, at pressures selected from between 0-300 PSI, and in still further preferred embodiments, at pressures selected from between 0-500 PSI (e.g., at various desirable volume delivery rates).

In the most preferred (but still non-limiting) example embodiments, a wide variety of pressures and volumes can be selected and delivered without requiring part swapping and/or substantial regulator adjustment. In certain particularly efficacious embodiments, no adjustment of the regulator is required when switching between end use applications (e.g., other than possibly of the output pressure knob). In some embodiments, the air/gas outlet is connected via an air/gas hose to a pneumatically operated tool, and the regulator may further include an air fill inlet, which may be connectable via an air hose, for example, to a reservoir or compressor for refilling an air tank connected to the regulator.

In another aspect, the present invention is directed to a portable pneumatic tool power supply system that includes (a) a two stage regulator that includes a housing having at least a first chamber and a second chamber in fluid communication with the first chamber; a high pressure cartridge assembly and a high pressure piston assembly housed within the first chamber; the high pressure cartridge assembly having an air inlet port, and a low pressure cartridge assembly and a low pressure piston assembly housed within the second chamber, the low pressure cartridge assembly having an air outlet port, the high pressure piston assembly including an outer piston and an inner piston housed at least partially within the outer piston and user moveable longitudinally within the outer piston; (b) a pressurized air tank; and (c) a hose connected to the air inlet port on one end and to the pressurized air tank on the other end.

In some embodiments, the portable pneumatic power supply system further includes a pneumatic tool and a hose connected to the air outlet port of the regulator on one end and to the pneumatic tool on the other end.

In certain embodiments described herein, having adjustability at both the first and second stages allows tunability of the regulator so that it can be readily used with a wide range of pneumatic tools (which utilize shot-type gas delivery or continuous flow delivery). In such or other embodiments, having first and second stage adjustability, additionally, or in the alternative, permits tunability so that the regulator delivers a generally or substantially stable output gas pressure regardless of the gas supply pressure (e.g., the pressure of the gas supplied by a high pressure steel, aluminum, or carbon fiber cylinder).

Certain examples of the invention are now below described with respect to certain non-limiting embodiments thereof as illustrated in the following drawings wherein:

### BRIEF DESCRIPTION OF THE DRAWINGS

FIG. 1A illustrates a plan view of one embodiment of a regulator according to the subject invention with certain parts shown in x-ray (shown with regulator pins in an “open” position).

FIG. 1B illustrates an exploded, plan view of the embodiment of the regulator illustrated in FIG. 1A.

FIG. 2A illustrates a top view of an embodiment of a high pressure regulator pin according to the subject invention.

FIG. 2B illustrates a profile view of an embodiment of a high pressure regulator pin according to the subject invention.

FIG. 2C illustrates a bottom view of an embodiment of a high pressure regulator pin according to the subject invention. FIG. 3A illustrates one embodiment of a high pressure piston assembly employed in the regulator illustrated in FIG. 1A, with certain parts shown in x-ray.

FIG. 3B illustrates an exploded view of the high pressure piston assembly illustrated in FIG. 3A.

FIG. 3C illustrates an assembled, perspective, non-x-ray view of the high pressure piston assembly illustrated in FIG. 3A.

FIG. 4 illustrates, in perspective view, one embodiment of a low pressure regulator pin according to the subject invention.

FIG. 5 illustrates an alternative embodiment of a regulator, in blown-apart view, according to the invention.

FIG. 6 illustrates an alternative embodiment of a regulator, in assembled view, according to the invention.

FIG. 7 illustrates high and low pressure cartridges which (optionally) form part of the alternative embodiment of a regulator depicted in FIG. 5.

### DETAILED DESCRIPTION OF CERTAIN EMBODIMENTS

For a more complete understanding of the present invention, reference is now made to the following description of various illustrative and non-limiting embodiments thereof, taken in conjunction with the accompanying drawings in which like reference numbers indicate like features.

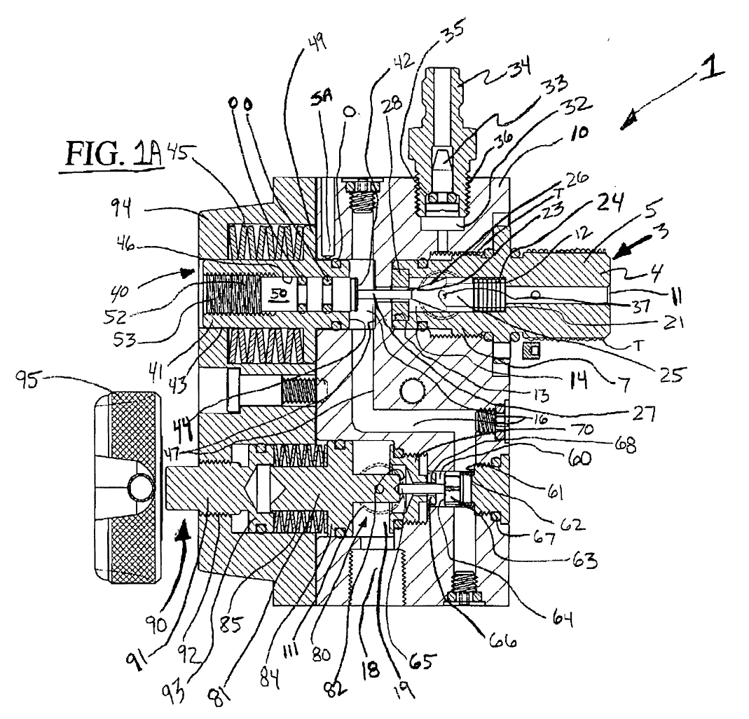

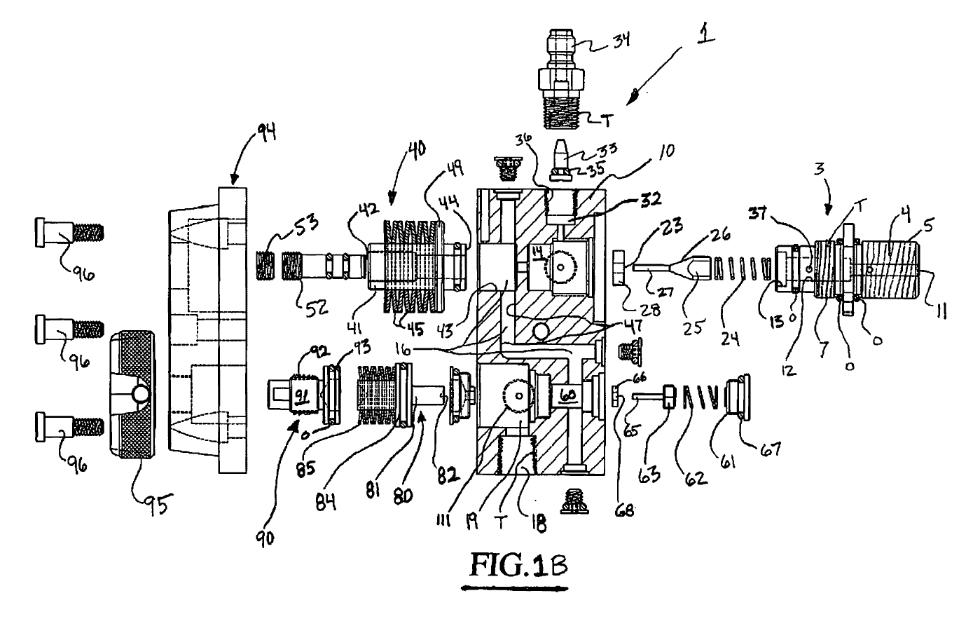

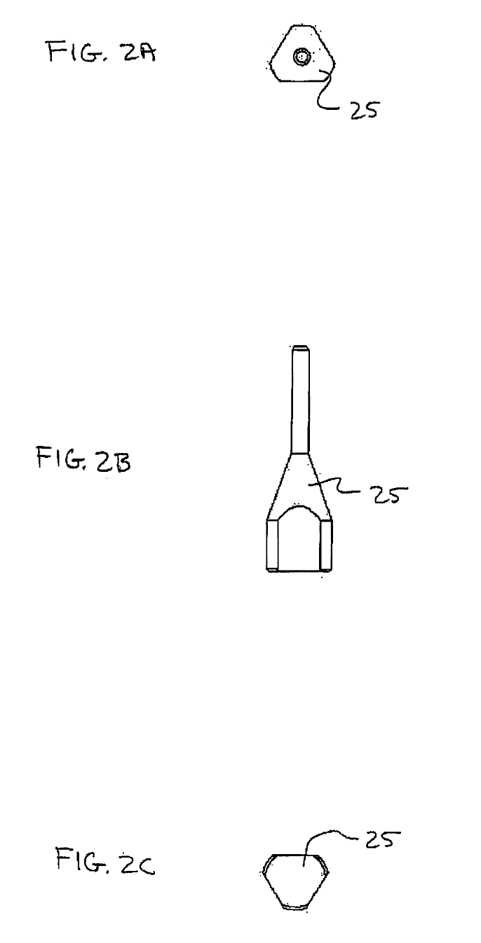

Referring initially to FIGS. 1 and 2, assembled and blown apart views of an example regulator according to the subject invention are illustrated therein. Such figures in this regard, illustrate regulator 1 as comprising an assembly of four main components or sub-assemblies including a high pressure sub-assembly, a low pressure sub-assembly, main regulator body 10, and regulator cap 94 each, as assembled together, comprising and/or operatively enclosing regulator 1's main functional components.

In this regard, regulator 1's high pressure sub-assembly is generally comprised of high pressure cartridge 3 which itself comprises a unibody cartridge body 4 having a first end 5 for threadably engaging a high pressure cylinder and a second end 7 for threadably engaging main regulator body 10. First end 5, in this regard, includes a high pressure input aperture 11 for gas flow communication with a high pressure cylinder to which it attaches (or is attached). At its opposite or second end 7, cartridge 3 includes a regulator seat aperture 13 for retaining a regulator seat 28, adjoined to a middle aperture 12 which serves both as a seat for a biasing mechanism 24 (e.g., a conventional coil spring or other suitable mechanism) as well as connects apertures 11 and 13 for gas flow communication therebetween. Additionally, as illustrated, middle aperture 12 houses a portion of regulator pin 25 (illustrated in detail in FIGS. 2A, 2B, and 2C) which has a first narrow, elongated end or tip 27 which is installed in a generally central aperture 23 of regulator seat 28 (itself press fit into aperture 13). Pin 25's opposite or second end, as can be seen in the figures, is in biasing contact with biasing mechanism 24 (e.g. a coil spring). It is noted, in this regard, that regulator pin 25 is moveable bi-directionally upwards and downwards within aperture 12 of cartridge 3 during regulator operation with such pin 25 acting to open or close the gas pathway to the low pressure side of the regulator by effectively “opening” and “closing” aperture 23 in regulator seat 28 as the conical or wide portion 26 of pin 25 moves out of and into engagement with the aperture respectively (e.g., by physically obstructing the air/gas passageway).

As can best be seen in FIG. 1, the entire high pressure cartridge 3 (e.g., including cartridge body 4 housing the above described regulator pin, spring, and regulator seat) connects to main regulator body 10 by simply threading thereto employing o-rings where appropriate to obtain or achieve necessary seals (threads, whether male or female, throughout the drawings are sometimes referred to by the designation “T”; similarly, for efficiency purposes, o-rings are sometimes designated employing the label “0”, rather than with a specific part number).

Generally opposite the location of installation of cartridge 3 to main regulator body 10 (preferably in axial alignment therewith), high pressure piston assembly 40 is housed in piston aperture or chamber 43. Installed as such, a low pressure chamber 16 is defined, in part, by the first end or portion 44 of the high pressure piston assembly and the opposing and adjoining walls of aperture 47 (thus, the volume of the low pressure chamber increases or decreases as the position of high pressure piston assembly 40 changes axially within the regulator).

In this example embodiment, high pressure piston assembly 40 generally comprises a generally cylindrical main piston body 41 having a shoulder or flange region 49. A plurality or bank of Bellville-springs 45 are installed on body 41 with one end of the bank of springs engaged to shoulder 49 of the piston assembly and the other end enclosed or “captured” by regulator cap 94 (which removably attaches to main regulator body 10 via male and female threaded portions, e.g., conventional bolts 96, in this embodiment, but which, of course, can be attaches by other mechanisms or means as well). Although Belleville-type springs (e.g., preferably stainless steel) have proven particularly effective in achieving good regulator performance characteristics, other spring types or biasing mechanisms may, of course, be employed.

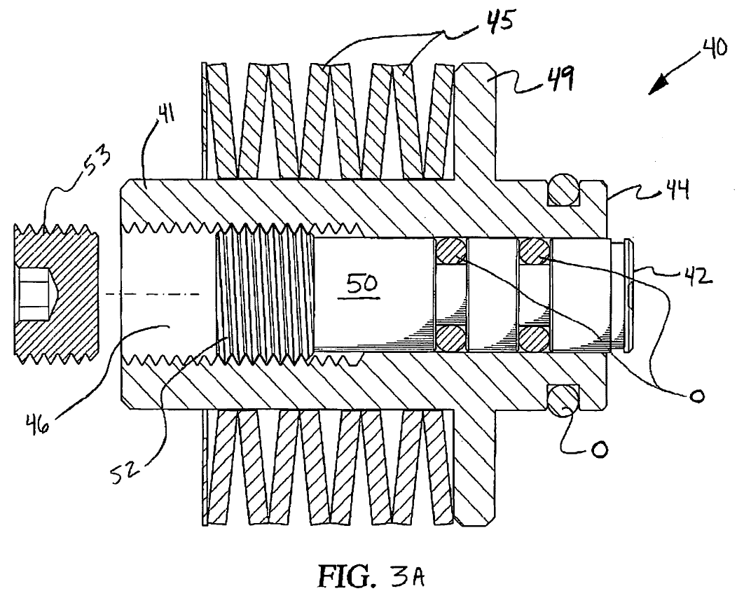

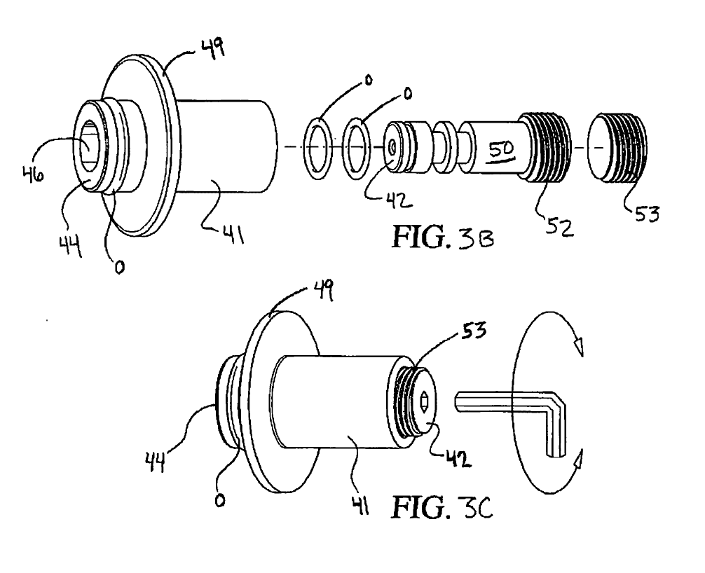

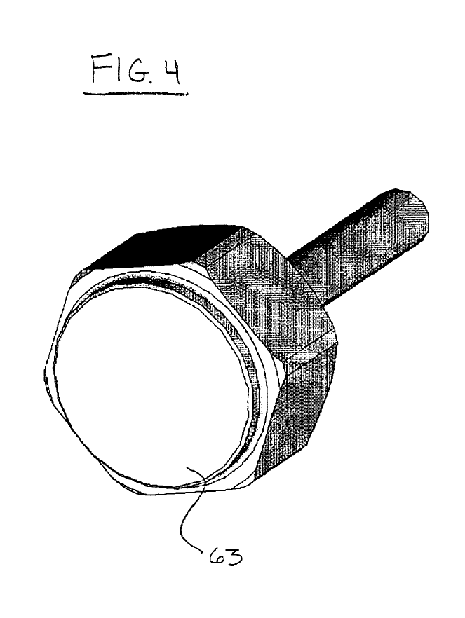

Notably, main piston body 41 has a central aperture 46 for retaining and/or engaging inner piston 50 which can be threaded into different axial positions within piston body 41 to change its effective length and therefore relative bias against regulator pin 25 (at its tip 27) to tune and/or adjust the output characteristics of the regulator (with o-rings being used about the diameter of inner piston 50 to obtain an airtight installation within piston body 41 as well as at least one o-ring being used on piston body 41 for an airtight seal between it and main body 10). In this regard, inner piston 50 includes a pin seat 42 (having a detent region, shown best in FIG. 3A) which, when the regulator is assembled, is in biasing engagement with regulator pin 25 via tip 27. Regulator pin 25, in turn, is biased in the opposite direction by biasing mechanism or spring 24. Having this configuration, it will be recognized, of course, that piston assembly 40 travels axially, back and forth, within piston chamber 43 as a function of internal system pressures and spring values during and as part of regulator operation. Moreover, it will be recognized that the axial position of inner piston 50 can be adjusted (within piston body 41) to change the “balance” of the opposing spring biasing forces provided by springs 24 and 45 (as relative to internal system air/gas pressures). Adjusting the axial position of inner piston 50, in this regard, allows volume and/or pressures of air/gas which travels or passes through regulator seat 28, during regulator operation, to be tailored or tuned as desired. In order to adjust piston 50, threaded plug or cap 53 can be removed by simply threading it out of cap 94 for access to the piston (see FIGS. 3A, 3B, and 3C for a more detailed view of piston assembly 40).

At the low pressure side of the regulator, and referring still to FIGS. 1 and 2, low pressure sub-assembly of regulator 1 generally comprises a spring seat 61 (threaded to main body 10 and sealed with o-ring 67, in this example), a spring (or other suitable biasing mechanism) 62, and a regulator pin 63 (hexagonally shaped to allow air/gas flow around its circumference; see FIG. 4) installed in a low pressure regulator chamber 60 with its tip 65 installed and extending within aperture 68 of regulator seat 66 (which is seated against and structurally supported, on one side, by deformable threaded insert 70). As can be seen in the drawings, spring 62 is installed positioned between seat 61 and pin 63 and therefore acts to bias regulator pin 63 towards the regulator seat 66 (i.e., it acts to bias it towards a sealing engagement with the regulator seat). Similar to the high pressure sub-assembly described herein, the low pressure sub-assembly further includes a low pressure piston assembly 80 located oriented generally coaxial and in-line with the axis of regulator pin 63. In this example embodiment, the low pressure piston assembly 80 generally comprises a piston body 81 having a shoulder or flange portion 84 for seating Bellville-type springs 85 (although other spring or biasing mechanism types may, of course, be employed). Moreover, piston body 81, similar to its high pressure counterpart, includes a low pressure pin seat 82 which engages low pressure regulator pin tip 65 in a biasing relationship (i.e., springs 85 provide a biasing force to piston body 81 which is applied against pin tip 65 via pin seat 82). Capturing springs 85 against shoulder 84 is an adjustment mechanism 90 which is provided so that the output pressure delivered by regulator 1 (via output port 18) can be user selected in accordance with pneumatic tool or other needs, for example. More specifically, adjustment mechanism 90 comprises an adjuster body 91 which is threadably engaged to cap 94 via threads 92. At one end, adjuster body 91 includes a flange portion 93 (with a corresponding o-ring for providing an appropriate air/gas seal) which, when installed in regulator 1, acts as a seat for springs 85. Configured as such, adjustment mechanism 90 can be employed to change or tune the biasing force provided against regulator pin 63 (at its tip 65) by threading adjuster body 91 axially farther in or farther out of regulator cap 94 thereby changing the amount of force applied against springs 85 by flange 93 (which in turn determines the amount of spring or biasing force applied against regulator pin 63). This is accomplished, in this embodiment, by merely hand turning adjustment knob 95 which, when assembled, is connected to body 91 to provide user adjustability of the force of springs 85. This, in turn, determines the relative balance or differential of opposing spring forces applied on regulator pin 63 (between springs 62 and 85), in combination with internal system air/gas pressures (which act to trigger the opening and closing of the regulator seat by pin 63 in combination with the spring forces), and thereby determines the amount of air flow (including volume and/or pressure) which is permitted to pass through regulator seat 66 during operation i.e., from low pressure chamber 16 to output chamber 19 through aperture 68.

As illustrated in the figures, output chamber 19 is in open air/gas communication with outlet port 18. Port 18, in this regard, is provided, in this embodiment, with threaded walls for accepting installation of a quick connect/disconnect type coupler for connecting to an air/gas hose, for example (e.g., for connection, in turn, to a pneumatic tool). Furthermore, in the illustrated embodiment, regulator 1 is provided with a fill pathway and fill port 34 for allowing pressurized air/gas to be introduced to an air/gas cylinder connected to the regulator, for example (not shown). The fill pathway includes a fill chamber 32, having threads 36 for threadably connecting to fill port 34 and a corresponding fill aperture 37 (in cartridge body 4) for providing air/gas communication between chamber 32 and aperture/pathway 11 (aperture 37 is in air/gas communication with chamber 32). Fill port, 34, in turn, includes a one-way valve type assembly comprised of a poppet or strut 33 selectively sealed and unsealed by an o-ring 35 during use and fill operations, respectively.

In operation, the two stage regulator which is illustrated is preferably attached to a portable, high pressure air/gas cylinder so that aperture 11 is in air/gas flow communication with a source of pressurized air/gas (e.g., as contained in the connected high pressure air/gas cylinder). In this regard, spring 24 will normally bias pin 25 against regulator seat 28 when the internal chambers (high and low) of the regulator are pressurized. However, when pressure is evacuated from low pressure chamber 16, such as during pneumatic tool use, for example (when air is evacuated from port 18), the corresponding drop in internal pressure in the low pressure chamber relieves biasing pressure from against the end 44 of the high pressure piston assembly thereby permitting springs 45 to overcome the opposing biasing force of spring 24. As a result, regulator pin 25 withdraws axially away from regulator seat 28 and permits pressurized air to reenter the low pressure chamber 16 from high pressure chamber 14 (via regulator seat aperture 23). After a threshold amount of pressure rebuilds in the low pressure chamber 16, air/gas force builds against high pressure piston face 44 and the high pressure piston assembly is urged back against the force of springs 45, allowing springs 24 to overcome the force of such springs (45) and for regulator pin 25 to reseat against regulator seat 28 and thereby close the air/gas communication between the low and high pressure chambers 14 and 16 (by physically obstructing the air passageway, at aperture 23, between them).

Similarly, prior to evacuation of pressure at output port 18 (e.g., during tool operation), the force of spring 62 combined with the air/gas pressure contained in output chamber 19, which applies force against the face of shoulder 84, is sufficient (when the regulator is properly tuned) to overcome the biasing force of springs 85 and therefore keep pin 63 seated against regulator seat 60, thereby preventing air/gas flow between the low pressure chamber and the output chamber. When, however, chamber 19 is evacuated (such as when a pneumatic tool, connected to port 18, is operated), the lack of internal air/gas pressure in chamber 19 (and therefore lack of air/gas force being applied to the face of shoulder 84) temporarily permits the force of springs 85 to overcome the force of spring 62 sufficiently long enough such that regulator pin 63 is biased away from regulator seat 66 by pin seat 82 (of the low pressure piston) such that air/gas of sufficient/desired pressure and/or volume is reintroduced into output chamber 19. At such time, the introduced pressure and/or volume is sufficient to reintroduce a bias force against springs 85 via air/gas force pressure on the face of shoulder 84 such that the force of spring 62, assisted by the air/gas force, overcomes the biasing force of springs 85, and aperture 68 of regulator seat 66 is once again closed by regulator pin 63 (because the pin is reseated against the regulator seat). In particular, adjustment mechanism 90 is provided so that the biasing force of springs 85, as they act on the low pressure piston assembly, can be manually adjusted (via knob 95) so that the amount of air pressure which is obtained in or provided to chamber 19 (and therefore provided at output port 18) is user selectable. In particular, this feature is provided so that a user can choose a desired output pressure for use with a particularly selected pneumatic tool or for another pneumatic use. Aiding in this purpose, certain embodiments of the regulator, such as the embodiment illustrated, are provided with a port/passageway 111 for connecting a pressure gauge (actual gauge, not shown) which permits accurate and active selection of output pressures. In certain particularly exemplary embodiments of the regulators described herein (such as the regulator illustrated), an optional safety feature is provided to the regulator. For example, as depicted best in FIG. 1, a safety aperture SA is provided which is bored through main regulator body 10. In the location depicted, if piston body 41 is advanced outwardly (away from regulator pin 25) a sufficient distance due to possibly unsafe high pressures in the regulator (perhaps because regulator seat 28 has failed and the full, high pressure of the cylinder is biasing piston body 41 upwardly), safety aperture SA becomes exposed to the atmosphere (it is normally sealed off from the atmosphere by certain o-rings depicted in the figures) and the pressurized air/gas contained within the regulator is allowed, at least in part, to off-gas thus minimizing or at least reducing the potential adverse effects of regulator part failure, for example.

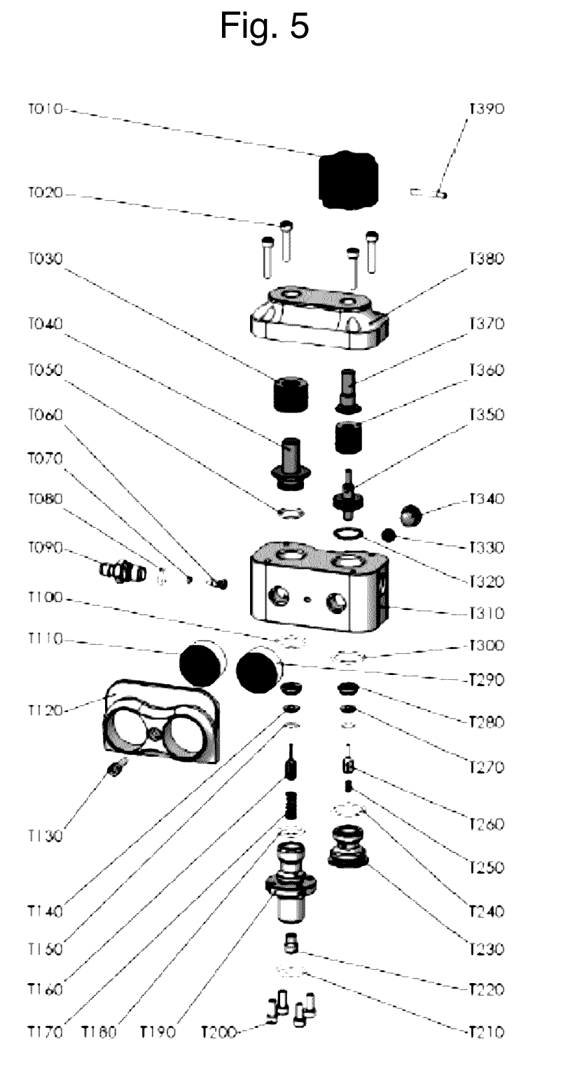

Alternative embodiments of an improved regulator, useful as part of a portable air/gas power supply system, are now described below in conjunction with FIGS. 5-7.

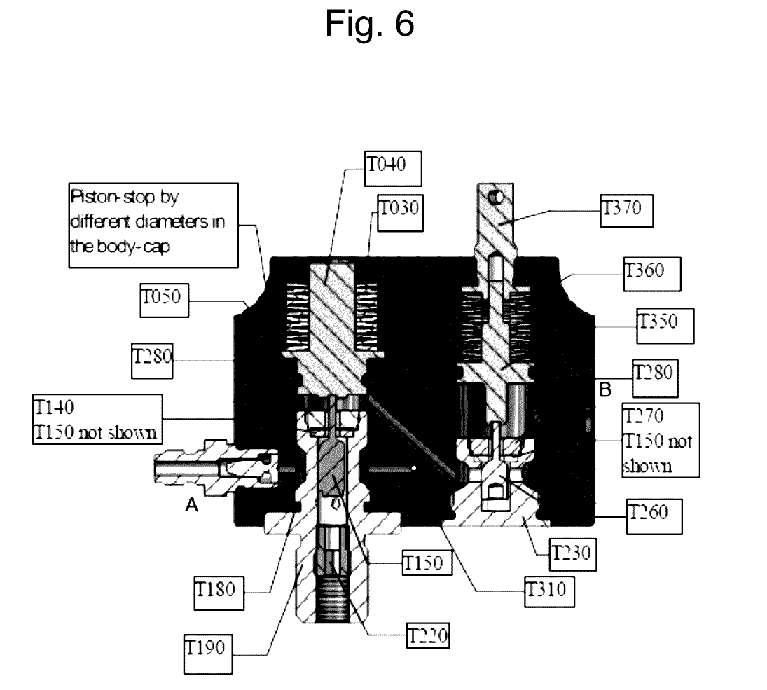

Turning now to FIGS. 5 and 6, assembled and blown apart views of an alternative regulator embodiment are illustrated therein. Such figures in this regard, illustrate such regulator as again comprising an assembly of four main components or sub-assemblies including a high pressure cartridge T190, a low pressure cartridge T230, main regulator body T310, and regulator cap T380 each, as assembled together, comprising and/or operatively enclosing the alternative regulator's main functional components.

The regulator's high pressure cartridge T190 comprises a unibody cartridge body having a first end for threadably engaging a high pressure cylinder and a second end for threadably engaging main regulator body T310. The first end includes a high pressure input aperture for gas flow communication with a high pressure cylinder to which it attaches (or is attached). At its opposite or second end, the cartridge T190 includes a regulator seat aperture for retaining a regulator poppet seat T150 assembled adjacent to o-ring T140. A high pressure poppet T160 is assembled between the high pressure cartridge body and main body T310 with spring T170 assembled and utilized to provide a biasing force against poppet T360. Poppet T160 is moveable bi-directionally upwards and downwards within cartridge T190 during regulator operation with such poppet acting to open or close the gas pathway to the high pressure side of the regulator by effectively “opening” and “closing” the air flow aperture in poppet seat T150 as the conical or wide portion of the poppet moves out of and into engagement with the poppet seat.

As can best be seen in FIG. 6, the entire high pressure cartridge T190 connects to main regulator body T310 by simply threading thereto employing o-rings T170 and T210 where appropriate to obtain or achieve necessary seals.

Generally opposite the location of installation of cartridge T190 to main regulator body T310 (preferably in axial alignment therewith), high pressure piston assembly T040 is housed in a piston aperture or chamber. In this example embodiment, high pressure piston assembly T040 generally comprises a generally cylindrical main piston body having a shoulder or flange region. A plurality or bank of Bellville-springs T030 are installed on piston T040 with one end of the bank of springs engaged to the shoulder of the piston assembly and the other end enclosed or “captured” by regulator cap T380 which removably attaches to main regulator body T310 via male and female threaded portions (e.g., conventional bolts T020, in this embodiment, but which, of course, can be attached by other mechanisms or means as well). Although Belleville-type springs (e.g., preferably stainless steel) have proven particularly effective in achieving good regulator performance characteristics, other spring types or biasing mechanisms may, of course, be employed.

Notably, regulator cap T380 has an aperture for retaining and/or engaging piston T040 which can (optionally) be threaded into different axial positions within cap T380 to change its effective length and therefore relative bias against poppet T160 to tune and/or adjust the output characteristics of the regulator (with o-rings T140 being used for an airtight seal). Having this configuration, it will be recognized that piston T040 travels axially, back and forth, within its piston chamber as a function of internal system pressures and spring values during and as part of regulator operation. Moreover, it will be recognized that the axial position of piston T040 can be adjusted to change the “balance” of the opposing spring biasing forces provided by springs T030 and T170 (as relative to internal system air/gas pressures). Adjusting the axial position of piston T040, in this regard, allows volume and/or pressures of air/gas which travels or passes through poppet seat T150, during regulator operation, to be tailored or tuned as desired.

At the low pressure side of the regulator, and referring still to FIGS. 5 and 6, the low pressure cartridge T230 further interacts with a low pressure piston T350 located oriented generally coaxial and in-line with the axis of the cartridge and installed low pressure poppet T260. In this example embodiment, the low pressure piston T350 generally comprises a piston body having a shoulder or flange portion for seating Bellville-type springs T360 (although other spring or biasing mechanism types may, of course, be employed). Moreover, piston body T350, similar to its high pressure counterpart, includes a low pressure poppet seat which engages the tip of low pressure poppet T260 in a biasing relationship (i.e., springs T360 provide a biasing force to piston T350 which is applied against the tip of poppet T260 via a poppet seat). Capturing springs T360 against the shoulder is an adjustment mechanism T370 which is provided so that the output pressure delivered by the regulator can be user selected in accordance with pneumatic tool or other needs, for example. More specifically, adjustment mechanism T370 comprises an adjuster body which is threadably engaged to cap T380 via threads. At one end, the adjuster body includes a flange portion which, when installed in the regulator, acts as a seat for springs T360. Configured as such, adjustment mechanism T370 can be employed to change or tune the biasing force provided against poppet T260 (at its tip) by threading the adjuster body axially farther in or farther out of regulator cap T380 thereby changing the amount of force applied against springs T360 by the flange (which in turn determines the amount of spring or biasing force applied against poppet T260). This is accomplished, in this embodiment, by merely hand turning adjustment knob T010 which, when assembled, is connected to mechanism T370 to provide user adjustability of the force of springs T360. This, in turn, determines the relative balance or differential of opposing spring forces applied on regulator poppet T260 (between springs T250 and T360), in combination with internal system air/gas pressures (which act to trigger the opening and closing of the regulator/poppet seat T270 by poppet T260 in combination with the spring forces), and thereby determines the amount of air flow (including volume and/or pressure) which is permitted to pass through regulator/poppet seat T270 during operation i.e., from the low pressure chamber to the output chamber and through the air/gas delivery aperture.

As illustrated in the figures, the regulator embodiment is preferably provided with a fill pathway and fill adapter T090 for allowing pressurized air/gas to be introduced to an air/gas cylinder connected to the regulator, for example (not shown). The fill pathway includes a fill chamber, having threads for threadably connecting to fill adapter T090 and a corresponding fill aperture. Fill adapter, T090, in turn, preferably includes a one-way valve type assembly comprised of a poppet or strut selectively sealed and unsealed by an o-ring during use and fill operations, respectively.

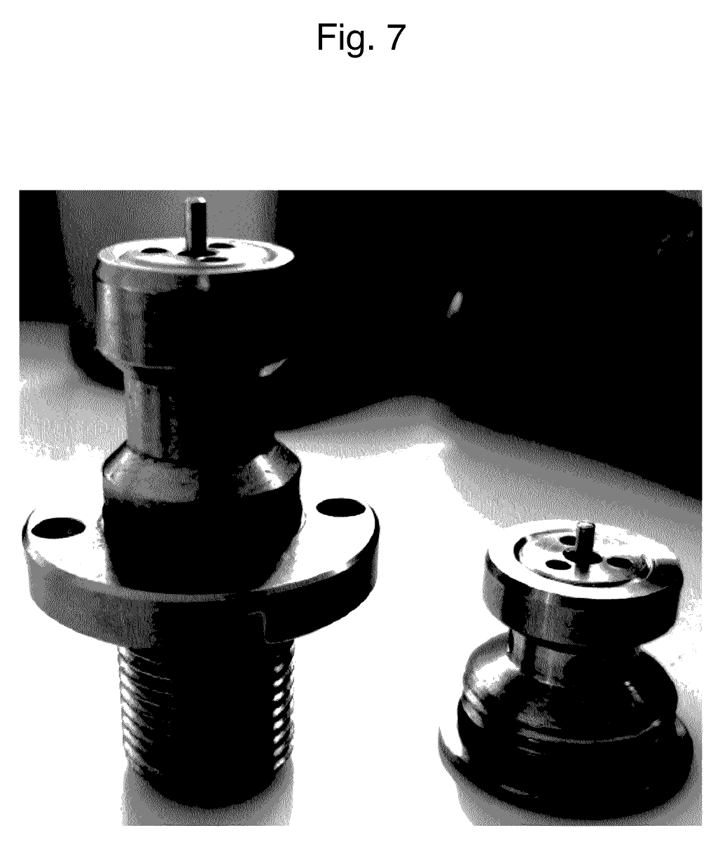

In the alternative embodiments depicted, the high pressure and lower pressure stages are formed into discrete or separate cartridges or units, such as depicted in FIG. 7, which are operable without being assembled to the main regulator body. This allows for the poppets and seats to be tested externally for proper function (e.g., by mounting on a test device). In order to accomplish this in this example embodiment, the poppet seat T140 is no longer fixed in the main body, but instead is located in the high pressure cartridge T190 itself. In order to hold or carry the seat, a hole is provided or machined into the body of cartridge T190 which is carefully sized so that the seat T140 fits with tight tolerances (e.g., substantially exactly within the space).

In order to provide an airtight seal, an o-ring is used and then all the parts are held in place/assembled together via a capscrew (e.g., T280 in one embodiment). That is, the capscrew holds the poppet, o-ring, and seat together as part of the high pressure cartridge. In preferred embodiments, the hole or aperture for the poppet (e.g., the elongated shaft portion thereof) and the aperture for the seat are machined together and aligned so that they are co-axial.

In at least one embodiment, by using an o-ring to seal the capscrew, the capscrew does not have to be overly tightened to ensure a proper or good air seal. Thus, seat is deformation is prevented.

In at least one embodiment (and in this embodiment in particular), the high-pressure cartridge is assembled to the regulator body using 4 bolts or screws T200 rather than being threaded externally itself. This avoids the threads scraping or scratching the receiving aperture of the main body (for the cartridge) and the reduces the incidence of or eliminates another opportunity for air leaks.

In the depicted embodiment, the poppet is guided in its linear movement (e.g., by its carrying aperture), thus eliminating or reducing the amount of lateral play of the poppet during operation. This ensures that the poppet contacts the seat, during operation, at a consistent location and therefore nests consistently in the same indented region of the seat to form a good air tight seal. Moreover, prior to normal regulator operation, the cartridges can be pressurized to a pre-selected, desirable pressure so that the poppet is forced against the seat at an ideal pressure and thus indents or imprints the seat to a functionally ideal depth. The seat, preferably formed of polyether ether ketone (PEEK), has a memory and thus the indentation or imprint remains for future pressurized poppet/seat interactions. In at least one embodiment, when assembling a regulator for consumer use, the combination of pre-indenting, or imprinting the seat at a selected pressure with the guided poppet motion provided by the improved high and low pressure cartridge design(s) provides predictable and reliable air tightness (as an improvement over prior designs) during regulator operation. Because of the improved seal obtained, and the improved reliability, increased pressures can be utilized within the regulator. This, in turn, allows for smaller air chambers to be used (while still carrying or delivering the same quantity of air because of the increased pressure), thus allowing less regulator material to be used during manufacture, and therefore lighter weight regulators may be obtained. This is an advantage given that the regulators are used, in certain embodiments, in portable air/power supply systems which are often man-carried. In view of these advantages, the Applicants view these features, including the described method of assembly including the pre-imprinting of the seats, to be within the scope of (and indeed the focus of) at least one embodiment of their invention.

In certain embodiments, the springs of the high pressure stage and the low-pressure stage are replaced by Bellville-washers. For this purpose, the geometry of the body cap, the adjusters, the low pressure and the high pressure pistons may be modified.

In certain embodiments, in the cap T380, a stop for the high pressure piston T040 is utilized or inserted to protect the Bellville-washer(s) package and to prevent the O-ring T050 from slipping over the top edge of the body 310 and possibly being destroyed.

In certain embodiments, at the air-fill-adapter T090, the thread is preferably (but optionally) changed from conical to cylindrical. For sealing, an additional O-ring T080 is inserted.

In certain embodiments, in order to separate the high-pressure side and the intermediate pressure side, an additional O-ring T100 can be used. For this purpose, a recess for the O-ring is shown located in the main body T310.

In certain embodiments, in the low pressure side when cartridge T230 has been threaded from below into body T310, an additional O-ring T300 is preferably inserted to separate pressure ranges.

In certain embodiments, knob T010 has alternative embodiments which differ by the position of the hole for the spring pin T390. In certain embodiments, this provides the opportunity to design the controller for two different pressure ranges (e.g., 150 psi and 250 psi).

In certain embodiments, in order to complement the other structural changes, the outer shape of the regulator has been straightened or aligned (e.g., main body T310, gauge-guard T120, and cap T380).

As stated elsewhere, in certain embodiments, different pressure ranges may be obtained by utilizing different thicknesses of Bellville washers T360 at the low pressure side.

Once given the above disclosure, many other features, modifications, and improvements will become apparent to the skilled artisan. Such features, modifications, and improvements are therefore considered to be part of this invention, without limitation imposed by the example embodiments described herein. Moreover, any word, term, phrase, feature, example, embodiment, or part or combination thereof, as used to describe or exemplify embodiments herein, unless unequivocally set forth as expressly uniquely defined or otherwise unequivocally set forth as limiting, is not intended to impart a narrowing scope to the invention in contravention of the ordinary meaning of the claim terms by which the scope of the patent property rights shall otherwise be determined:

1. A regulator (1) comprising:
a regulator body (10) including an inlet port (11) for connecting to a high pressure gas supply, and said regulator housing a first stage (3, 40) and a second stage (80, 90);
said first stage (3, 40) including a first regulator piston (40) and a first regulator seat (28) and pin assembly (24, 25) for regulating air delivery between a high pressure chamber (14) and a low pressure chamber (16) of said regulator (1);
said second stage including a second regulator piston (80) and a second regulator seat (66) and pin assembly (62, 62) for regulating air delivery between said low pressure chamber (16) and an output chamber (19);
an output port (18) in gas flow communication with said output chamber (19) for delivering gas pressure at a desirable output pressure;
said regulator (1) characterized in that it includes:
a first adjuster mechanism (40, 41, 45, 50) included in operational communication with said first stage (3, 40) for adjusting at least one operational parameter of said first stage (3, 40);
said first adjuster mechanism (40, 41, 45, 50) comprising a piston assembly (41, 45, 50) having an outer piston (41) and an inner piston (50), said inner piston (50) being axially adjustable with respect to said outer piston (41) by a threaded connection between the inner piston (50) and the outer piston (41);
a second adjuster mechanism (90) included in operational communication with second stage (80, 90) for adjusting at least one operational parameter of said second stage (80, 90); and
wherein said first adjuster mechanism (40, 41, 45, 50) and said second adjuster mechanism (90) are each adjustable, alone or in combination, to tune performance of said regulator (1) to have desirable operational characteristics.

2. A regulator according to claim 1 wherein the inner piston (50) is in general coaxial alignment with the outer piston (41).

3. A regulator (1) according to claim 2 wherein the outer piston (41) is biased by a spring (45) and wherein the axial position of said inner piston (50) within said outer piston (41) determines a relative biasing force of said spring (45) against said pin assembly (24, 25).

4. A regulator (1) according to claim 3 wherein said second adjuster mechanism comprises the a low pressure adjuster further comprises including a shaft (91) having a first end which is threaded for connecting connected to a knob (95), and a second end having a flange (93) for operationally engaging said second regulator low pressure piston (80) via a spring (85) interposed therebetween.

5. A regulator according to claim 4 where the low pressure piston is biased by a spring.

6. A regulator (1) according to claim 4 wherein the first stage pin assembly (24, 25) high pressure pin assembly is in general coaxial alignment with the inlet port (11).

7. A regulator (1) according to claim 6 further comprising a regulator cap (94) for securing the first regulator piston (40) and the second regulator piston (80) to the regulator body (10); wherein the regulator cap (94) is secured to the regulator body (10) with at least one screw male/female threaded portion (96); and wherein the first regulator piston (40) is adjustable through the regulator cap (94) and the second regulator piston (80) is adjustable via an said knob (95) located exterior to on the outside of the regulator cap.

8. A regulator (1) according to claim 1 wherein the low pressure chamber (16) is sized and configured in combination with the overall regulator (1) configuration to allow for a continuous gas flow at a constant pressure between the low pressure chamber (16) and the outlet output port (18).

9. A regulator (1) according to claim 1 wherein said first and second adjuster mechanisms (40, 41, 45, 50; and 90) are adjustable to selectively tune said regulator (1) to be capable of delivering gas, via said outlet output port (18), in the alternative or in combination, at low pressures, at high pressures, at low volume, at high volume, in shots, and as continuous flow.

10. A regulator according to claim 1 utilizing independent high and/or low pressure cartridges.

11. A method of making a regulator according to claim 1 where a poppet seat is pre-imprinted or indented prior to assembly to a main regulator body.

12. A regulator according to claim 1 in combination with a portable air power supply system.
